(19) United States
(12) Patent Application Publication
(10) Pub. No.: US 2008/0189647 A1
(43) Pub. Date: Aug. 7, 2008

(54) SYSTEM AND METHOD FOR INLINE VIEWING OF FILE CONTENT

(75) Inventor: David TAPUSKA, Waterloo (CA)

Correspondence Address: FASKEN MARTINEAU DUMOULIN LLP, 4200 TORONTO DOMINION BANK TOWER, BOX 20 TORONTO-DOMINION CENTRE, TORONTO, ON, M5K 1N6, omitted

(73) Assignee: RESEARCH IN MOTION LIMITED

(21) Appl. No.: 11/670,271

(22) Filed: Feb. 1, 2007

(51) Int. Cl. G06F 3/048

(52) U.S. Cl. 715/781

(57) ABSTRACT

There is disclosed a system and method for viewing the contents of a file. A method in accordance with an embodiment comprises receiving a selection of a file in a list of files; opening an inline viewing window adjacent the position of the selected file; and displaying in the inline viewing window at least a portion of the contents of the selected file. The method may further comprise setting a size restriction for the inline viewing window, and restricting the display of contents of the selected file within the inline viewing window in dependence upon the set size restriction. A maximum expandable size for the inline viewing window, or the inline viewing window may be expandable to show the entire contents of a file. Other files in the list may remain viewable by scrolling past the inline viewing window.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### FIELD OF THE INVENTION

The present invention relates generally to systems and methods for viewing file content.

### BACKGROUND

Recent advances in wireless communication technologies and increased wireless network bandwidth capacities have led to the development and availability of wireless Internet access with web browsing capabilities on mobile handheld communication devices. However, as compactness and portability is a key requirement for such devices, the size of the display provided on the handheld device may be limited to no more than a few inches across diagonally.

On such a small display, it may be challenging to view web pages that have been formatted to be viewed on a typical full size display. In particular, it may be especially challenging to efficiently review a list of web pages, or other types of files, to quickly get a sense of their content.

What is needed is a system and method for viewing file content, such as web pages, that may overcome some of the above limitations.

### BRIEF DESCRIPTION OF THE DRAWINGS

In the figures which illustrate exemplary embodiments:

FIG. 1 is a schematic block diagram of various components that may be found in a handheld mobile communication device;

FIG. 2 is an illustrative example of a handheld mobile communication device that may provide an operating environment;

FIG. 3 is an illustrative view of a display screen 300 of a data sorted list that may appear on the handheld mobile communication device of FIG. 2;

FIG. 4 is an illustrative view of another display screen 400 showing the contents of a selected item in the display screen 300 of FIG. 3;

FIG. 5 is an illustrative example of an inline viewing window for viewing the contents of a file;

FIG. 6 is an illustrative example of an inline viewing window having content which may extend beyond the display;

FIG. 7 is an illustrative example of the bottom portion of the inline viewing window of FIG. 6 as viewed on the display;

FIG. 8 is an illustrative example of an inline viewing window content including a graphic element;

FIG. 9 is an illustrative example of an inline viewing window for viewing email messages in accordance with an embodiment; and

FIG. 10 is a schematic flow chart of an illustrative method in accordance with an embodiment.

### DETAILED DESCRIPTION

As noted above, the present invention relates to a system and method for inline viewing of file content, such as the content of web pages and other files.

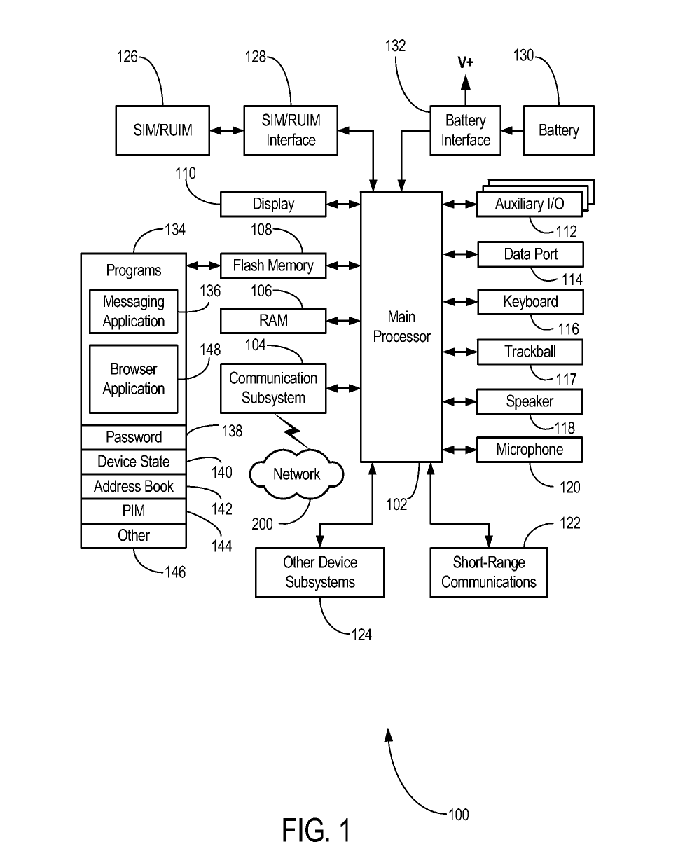

In an illustrative embodiment, the invention may be practiced with a handheld mobile communication device in a wireless operating environment. Shown in FIG. 1 is a schematic block diagram of an illustrative mobile communication device 100. The communication device 100 may comprise a number of components, including a main processor 102 which controls the overall operation of communication device 100. Communication functions, including data and voice communications, may be performed through a communication subsystem 104. The communication subsystem 104 may receive messages from and sends messages to a wireless network 200.

The main processor 102 may also interact with additional subsystems such as a random access memory (RAM) 106, a flash memory 108, a display 110, an auxiliary input/output (I/O) subsystem 112, a data port 114, a keyboard 116, a trackball 117, a speaker 118, a microphone 120, short-range communications 122 and other device subsystems 124 (such as a GPS subsystem).

Some of the subsystems of the communication device 100 may perform communication-related functions, whereas other subsystems may provide “resident” or on-device functions. By way of example, the display 110 and the keyboard 116 may be used for both communication-related functions, such as entering a text message for transmission over the network 200, and device-resident functions such as a calculator or task list. The trackball 117 may be used for various navigation functions, such as navigating through a graphical user interface (GUI) menu displayed on display 110. The trackball 117 may also be configured with a secondary actuation feature, such as allowing a user to depress the trackball, to allow selection of a highlighted item.

Operating system software used by the main processor 102 is typically stored in a persistent store such as flash memory 108. Those skilled in the art will appreciate that the operating system, specific device applications, or parts thereof, may be temporarily loaded into a volatile store such as the RAM 106.

The communication device 100 may send and receive communication signals over the wireless network 200 after required network registration or activation procedures have been completed. Network access may be associated with a subscriber or user of the communication device 100.

The communication device 100 may be a battery-powered device and may include a battery interface 132 for receiving one or more rechargeable batteries 130. In some embodiments, the battery 130 may be a smart battery with an embedded microprocessor. The battery interface 132 is coupled to a regulator (not shown), which assists the battery 130 in providing power V+ to the communication device 100.

The main processor 102, in addition to its operating system functions, enables execution of software applications 134 on the communication device 100. The subset of software applications 134 that control basic device operations, including data and voice communication applications, will normally be installed on the communication device 100 during its manufacture.

The software applications 134 may include a messaging application 136. The messaging application 136 can be any suitable software program that allows a subscriber or user of the communication device 100 to send and receive wireless text communications. Various alternatives exist for the messaging application 136 as is well known to those skilled in the art. Messages that have been sent or received by the user are typically stored in local storage such as flash memory 108 of the communication device 100, or in some other suitable storage element in the communication device 100. In an alternative embodiment, some of the sent and received messages may be stored remotely from the device 100 such as in a data store of an associated host system that the communication device 100 communicates with.

Another program that may be executed by the communication device 100 is a password approval module 138 that may provide approval for user passwords. The password approval module 138 may execute a password approval method to determine whether the user password specified by the user of the communication device 100 is approved.

The communication device 100 may further include a device state module 140, an address book 142, a Personal Information Manager (PIM) 144, and various other modules 146. Additional software applications may also be loaded onto the communication device 100 through at least one of the wireless network 200, the auxiliary I/O subsystem 112, the data port 114, the short-range communications subsystem 122, or other device subsystem 124.

The communication device 100 may also include a browser application module 148 that may be configured to handle various file content browsing functions on device 100 in accordance with various embodiments. A more detailed description of browser application module 148 will follow further below.

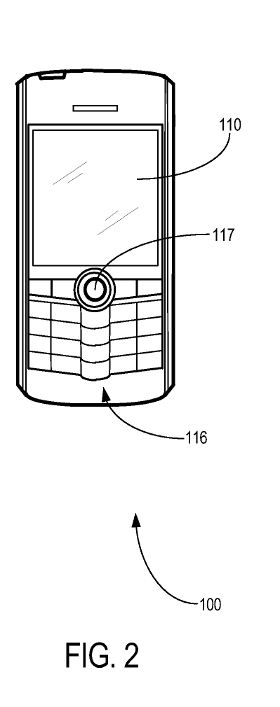

Now referring to FIG. 2, shown is an illustrative front view of a handheld mobile communication device 100 that may provide a suitable operating environment. As shown, the communication device 100 may include a display 110, a keyboard 116, and other input or navigation means such as a trackball 117. The display 110 may be configured to display various screens allowing the user of device 100 to view screen outputs from the browser application module 148, and to provide an input in response to a prompt or query displayed on display 110.

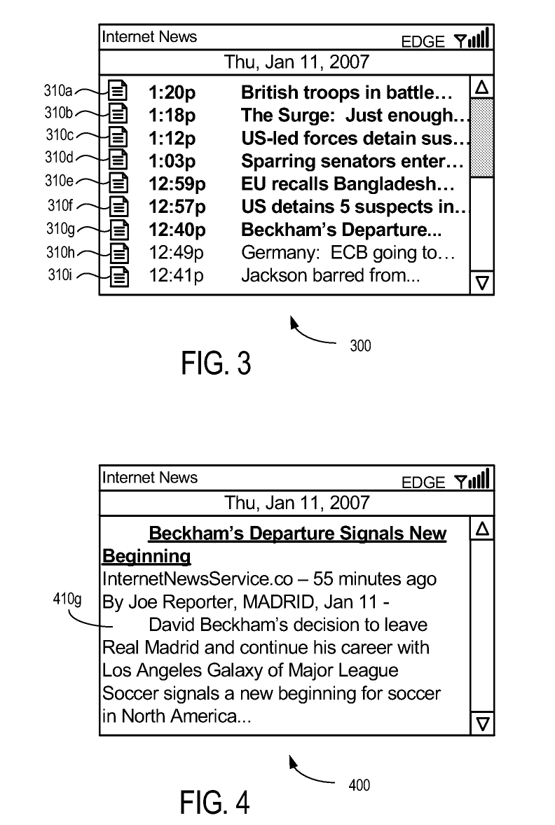

Now referring to FIG. 3, in an embodiment, browser application module 148 may be configured to provide a data sorted list of files, such as files 310a-310i shown on screen 300. For example, as shown, the data sorted list of files 310a-310i may be sorted chronologically with the most recent items at the top. It will be appreciated, however, that the files could also be sorted in reverse order with the most dated items first, or could be sorted based on any other sortable field.

In this illustrative example, the files relate to web pages rendered to HTML or XHTML, and pushed out to communication device 100. Presently, web feed syndication formats such as RSS (including Really Simple Syndication (RSS 2.0); Rich Site Summary (RSS 0.91, RSS 1.0); and RDF Site Summary (RSS 0.9 and 1.0)—see for example RSS: http://en.wikipedia.org/wiki/RSS_(protocol)) and ATOM (see for example the IETF for ATOM: http://www.ietf.org/html.charters/atompub-charter.html) are emerging as the most popular formats for syndicating and for subscribing to frequently updated web page content, such as news, business, and sports.

By way of illustration, suppose that the user of a mobile handheld communication device 100 subscribes to a syndicated RSS web feed, and is interested in a particular news item, namely file 310g with a time stamp of 12:40 pm and starting with the title “Beckham's Departure . . . ”.

In FIG. 4, screen 400 shows a typical conventional presentation of the contents of file 310g, which may be a full-page view occupying a significant portion of, or all of the display 110 of communication device 100. This may be quite acceptable if the user is interested in viewing the content of file 310g at length. However, this approach has the drawback of hiding all of the other files 310a-310f, 310h and 310i from view, and requiring a step back to a previous window to view the list of files 310a-310i. A more efficient way to preview the contents of the data sorted list of web page feeds would be desirable.

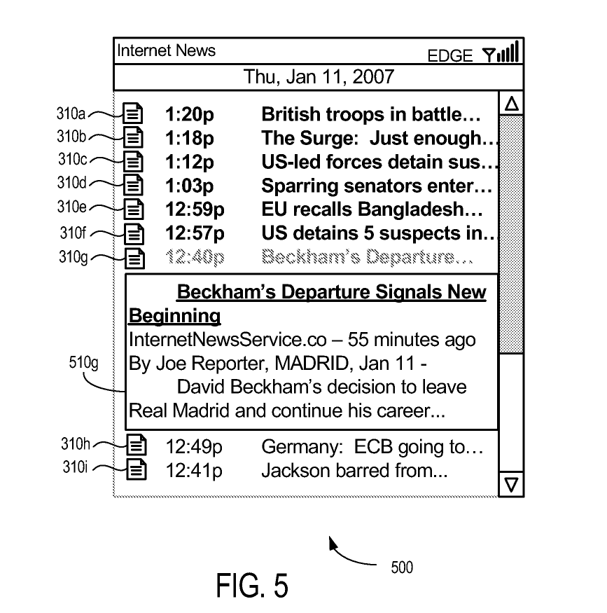

Now referring to FIG. 5, shown is an illustrative screen 500 in which an inline viewing window 510g opened at the position of a selected file 310g within the data sorted list. In this example, inline viewing window 510g is opened immediately below and adjacent the listing of selected file 310g, and at least a portion of the content of file 310g is shown in the inline viewing window 510g. For example, if file 310g is an Internet news web page, inline viewing window 510g may include the title, time posted, author, location, date, and a portion of the text. Significantly, the inline viewing window 510g is displayed in situ within the data sorted list of files 310a-310i, and allows the user to simultaneously see a preview of the content of a file, as well as the other files (e.g. other Internet news web pages) available in the data sorted list.

As will be appreciated, by viewing a short preview of each of the files in an inline viewing window 510, a user may be able to more quickly scan through the data sorted list of files 310a-310i to determine which of the files, if any, are of interest to the user. For example, the user could quickly preview a file with a title that initially catches his attention, but which might be misleading. Take for example a news item entitled, “Alligators found on Mars . . . ” which might actually have the full title “Alligators found on Marsland swamp lands” when previewed, and have nothing to do with what originally attracted the user.

In an embodiment, the browser application module 148 may be configured such that the inline viewing window 510 may be generated automatically upon the user selecting any one of the files 310a-310i in the data sorted list. Browser application module 148 may be configured such that if the user selects another of the files 310a-310i, then the inline viewing window 510 for the previously selected file 310a-310i may be closed automatically. Thus, in an embodiment, one inline viewing window 510 may be open at any one time. However, in another embodiment, browser application module 148 may be configured such that multiple inline windows may be opened. In this case, the data sorted list of files 310a-310i may keep expanding, with files separated by multiple, open inline windows.

Once each file 310a-310i has been viewed, it may be marked as being read. In an embodiment, browser application module 148 may be configured such that the “read” indication may be automatically turn on if the user views a preview, selects “Mark as opened” from a menu option, or clicks “Read story” directly, without viewing the preview.

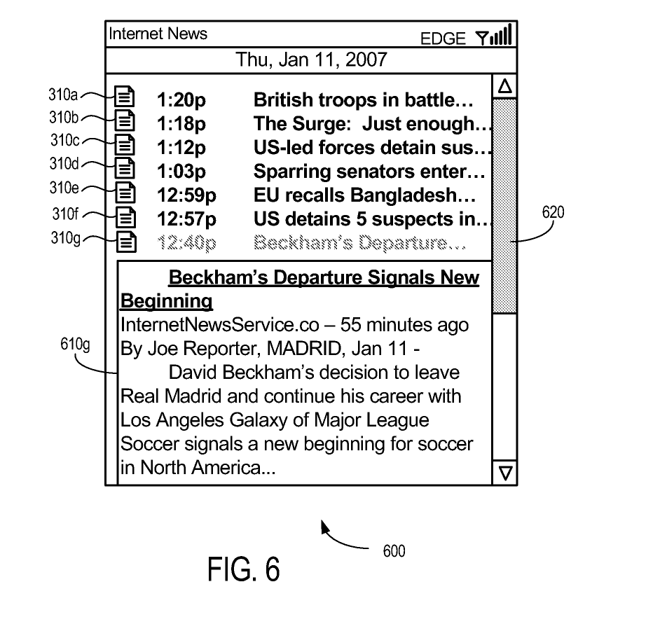

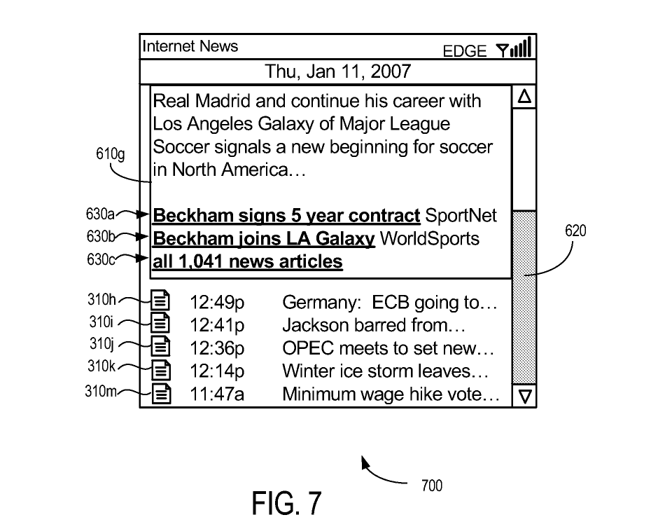

In the illustrative embodiment shown in FIG. 5, the size of the inline viewing window 510g may be fixed, such that it occupies a predetermined portion of the display 110. However, in an alternative embodiment, the inline viewing window may be automatically resized to accommodate preview content identified within a web page. By way of illustration, referring to FIG. 6, the inline viewing window 610 may be sized such that it may show more of the content of the selected file. In this illustrative example, inline viewing window 610g is larger than the inline viewing window 510g shown in FIG. 5, and extends beyond the bottom of screen 600. In this event, scroll bar 620 may be used to scroll down the screen 600 to view the rest of inline viewing window 610. This is illustrated by way of example in screen 700 of FIG. 7, and may allow access to associated web feeds such as shown at links 630a-630c.

Still referring to FIG. 7, as the user continues to scroll down the data sorted list of files, additional files 310h-310m that were previously not viewable on display 110 may now be displayed. Again, if the user wishes to see a preview of the contents for any of the data sorted list of files 310a-310m, the user may simply scroll up or down and manually select the relevant file to view. It will be appreciated that this may provide the user with a seamless viewing experience, such that the user will not have to leave the data sorted list of files 310a-310m.

In an embodiment, browser application module 148 may be configured such that the user may select a file for which to open an inline viewing window using a user actionable control. For example, the user actionable control may be a single-click of trackball 117. Similarly, browser application module 148 may be configured such that another single-click on the file with an open inline viewing window may effectively unselect the file, and close the inline viewing window. In either case, if desired, rather than acting immediately on a user command to open or close an inline viewing window, browser application module 148 may be configured such that a menu with a confirmation appear.

In another embodiment, browser application module 148 may be configured to provide an inline viewing window for a file after a cursor or other selecting tool is placed on a file for more than a predetermined time.

In yet another embodiment, browser application module 148 may be configured such that user may use a single-click of trackball 117 to select a listed file and open an inline viewing window to show a preview of the contents of the selected file. If, on the other hand, the user double-clicks on the listed item using trackball 117 within a predefined interval, then a full-page view of FIG. 4 may be presented. Alternatively, a menu may be provided to allow the user to select a “Full-page view”. While an illustrative example of a trackball 117 is provided, it will be appreciated that virtually any user actionable control on device 100 may be used to initiate the inline viewing window.

In another embodiment, browser application module 148 may be configured to provide an automatic viewing mode, such that a scrolling action downward or upward automatically shows a preview of each file in the data sorted list without the need to individually select those files. The opening of an inline viewing window for the next adjacent file (depending on the direction of scrolling) may be triggered, for example, by the user reaching past the limit of a set size restriction for the inline viewing window of the current file being viewed. In this automatic inline viewing mode, the user may avoid the tedious task of selecting each file individually, just to get an idea of its contents. In this automatic inline viewing mode, upon seeing a preview of the contents of a file that the user wishes to read in full, the user may select a full-page view by selecting “More” from a menu item, for example. In an alternative configuration, the browser application module 148 may be configured to allow the inline viewing window to expand without limit, thus allowing the user to view the entire content of a file within the inline viewing window.

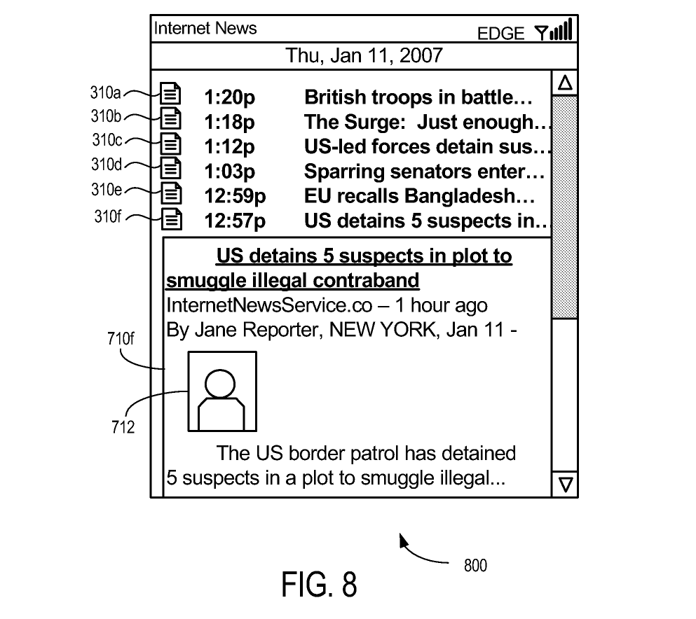

Now referring to FIG. 8, as illustrated in screen 800, an open inline viewing window 710f may show at least some of the content for corresponding file 310f. As illustrated, inline viewing window 710f may be capable of showing embedded graphic images, such as image 712 shown. It will also be appreciated that inline viewing window 810f may be configured to show other types of content that may be included and displayed on a web page.

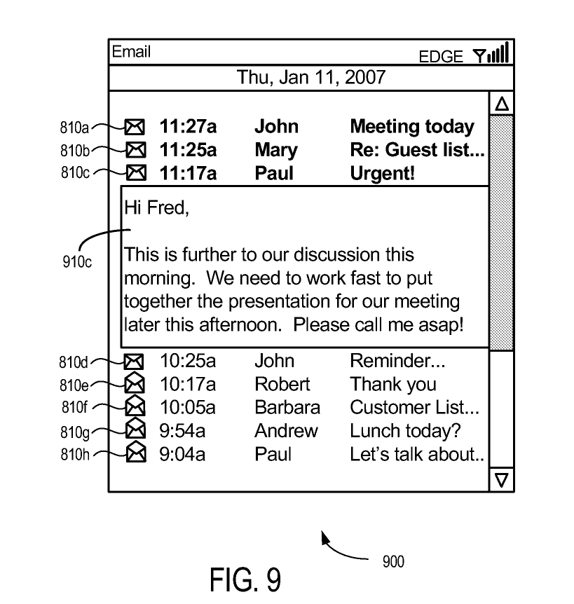

While the above illustrative embodiments relate to previewing the contents of web pages, it will be appreciated that in other embodiments various other types of files may be previewed in a similar manner. For example, as illustrated in screen 900 of FIG. 9, a plurality of email messages may be provided in reverse chronological order. Instead of having to open each email to view its contents, an inline viewing window 910c may be used to preview the contents of a selected email message. As illustrated, inline viewing window 910c may show the first few lines of email message 810c. Again, instead of a full-page view, the inline viewing window 910c allows the user to preview email message 810c but keep the list of other emails in view. This may, for example, allow the user to quickly scan the list of emails to identify other messages from the same sender and quickly jump to those messages to preview or view in full.

Again, the size of the inline viewing window 910c may be fixed, or it may be automatically resizable to a predetermined maximum size. Alternatively, the inline viewing window 910c may be extendable without limit to show the full contents of the email message.

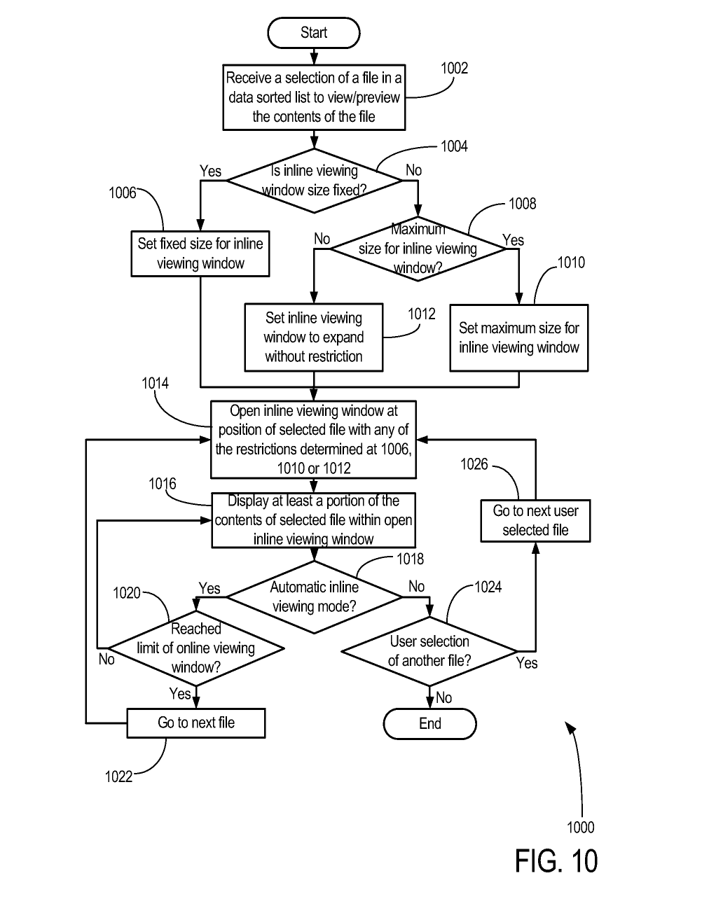

Now referring to FIG. 10, shown is a schematic flowchart of an illustrative method 1000 as may be embodied in and practiced using an appropriately configured browser application module 148, for example.

Method 1000 begins at block 1002, where method 1000 receives a user instruction to preview the contents of one or more files in a data sorted list. Upon receiving the user instruction, method 1000 may proceed to decision block 1004 where method 1000 determines if the size of the size of the inline viewing window is to be fixed or adjustable. If it is to be fixed, method 1000 proceeds to block 1006, where method 1000 sets a fixed size for the inline viewing window (such as illustrated in FIG. 5, for example).

If it is to be adjustable, method 1000 proceeds to decision block 1008, where method 1000 determines if there is a maximum size defined for the inline viewing window. If yes, method 1000 proceeds to block 1010, where method 1000 sets a maximum defined size for the inline viewing window. If no, method 1000 proceeds to block 1012, where method 1000 sets the inline viewing window to expand without restriction.

Method 1000 then proceeds to block 1014, where method 1000 opens the inline viewing window within the data sorted list, with any one of the restrictions determined at block 1006, 1010 or block 1012. Method 1000 then proceeds to block 1016, where method 1000 allows the contents of a selected file (e.g. a webpage or an email message) to be viewed within the opened inline viewing window, with any inline viewing window size restrictions that have been set.

Method 1000 may then proceed to decision block 1018, where method 1000 may determine if the user has selected an “automatic” inline viewing mode. If yes, method 1000 may proceed to decision block 1020, where method 1000 may determine if the limit of the inline viewing window has been reached by scrolling. If yes, method 1000 may proceed to block 1022 where method 1000 may go to the next file in the data sorted list (depending on the direction the user is scrolling), and return to block 1014 to open another inline viewing window for the newly selected file within the data sorted list. If no, method 1000 may return to block 1016 to continue to display the content of the currently selected file within the inline viewing window.

If at decision block 1018 the answer is no, method 1000 may proceed to decision block 1024, where method 1000 may wait for manual selection of another file by the user. If yes, method 1000 may proceed to block 1022, where method 1000 goes to the next file selected by the user. Method 1000 then returns to block 1014 to open another inline viewing window. If no, method 1000 ends.

As will be appreciated, by opening an inline viewing window, and allowing a user to control the size of the inline viewing window as described above, the user may have considerable flexibility in viewing, or quickly previewing files within a data sorted list. Also, while the above illustrative embodiments relate to viewing or previewing the content of web pages and email messages, it will be appreciated that virtually any type of file with content viewable as text or graphics may be viewed or previewed inline, as described above. Finally, while the inline viewing window is particularly useful on small displays, such as may be found on mobile handheld communication device 100 as described above, it will be appreciated that the same concept may be used to view or preview files in any data sorted list on a display of any size.

Thus, in an aspect, there is provided a method of viewing the contents of a file, comprising: receiving a selection of a file in a list of files; opening an inline viewing window adjacent the position of the selected file; and displaying in the inline viewing window at least a portion of the contents of the selected file.

In an embodiment, the method further comprises setting a size restriction for the inline viewing window, and restricting the display of contents of the selected file within the inline viewing window in dependence upon the set size restriction.

In another embodiment, the method further comprises setting a maximum expandable size for the inline viewing window.

In another embodiment, the method further comprises configuring a user actionable control to select a file.

In another embodiment, the method further comprises configuring automatic selection of the next adjacent file in the list of files.

In another embodiment, the method further comprises triggering selection of the next adjacent file based on scrolling past the limit of a set size restriction for the inline viewing window for the currently selected file.

In another embodiment, the method further comprises configuring a user actionable control to unselect a file, such that the inline viewing window for the unselected file is closed.

In another aspect, there is provided a system for viewing the contents of a file, comprising: means for receiving a selection of a file in a list of files; means for opening an inline viewing window adjacent the position of the selected file; and means for displaying in the inline viewing window at least a portion of the contents of the selected file.

In an embodiment, the system further comprises means for setting a size restriction for the inline viewing window, and restricting the display of contents of the selected file within the inline viewing window in dependence upon the set size restriction.

In another embodiment, the system further comprises means for setting a maximum expandable size for the inline viewing window.

In another embodiment, the system further comprises means for configuring a user actionable control to select a file.

In another embodiment, the system further comprises means for configuring automatic selection of the next adjacent file in the list of files.

In another embodiment, the system further comprises means for triggering selection of the next adjacent file based on scrolling past the limit of a set size restriction for the inline viewing window for the currently selected file.

In another embodiment, the system further comprises means for configuring a user actionable control to unselect a file, such that the inline viewing window for the unselected file is closed.

In another aspect, there is provided a data processor readable medium containing data processor code that when loaded into a device adapts the device to display the contents of a file, the data processor medium comprising: code for receiving a selection of a file in a list of files; code for opening an inline viewing window adjacent the position of the selected file; and code for displaying in the inline viewing window at least a portion of the contents of the selected file.

In an embodiment, the data processor medium further comprises code for setting a size restriction for the inline viewing window, and restricting the display of contents of the selected file within the inline viewing window in dependence upon the set size restriction.

In another embodiment, the data processor medium further comprises code for setting a maximum expandable size for the inline viewing window.

In another embodiment, the data processor medium further comprises code for configuring a user actionable control to select a file.

In another embodiment, the data processor medium further comprises code for configuring automatic selection of the next adjacent file in the list of files.

In another embodiment, the data processor medium further comprises code for triggering selection of the next adjacent file based on scrolling past the limit of a set size restriction of the inline viewing window for the currently selected file.

In another embodiment, the data processor medium further comprises code for configuring a user actionable control to unselect a file, such that the inline viewing window for the unselected file is closed.

While illustrative embodiments have been described above, it will be appreciated that various changes and modifications may be made. More generally, the scope of the invention is defined by the following claims.

What is claimed is:

1. A method of viewing the contents of a file, comprising:
receiving a selection of a file in a list of files;
opening an inline viewing window adjacent the position of the selected file; and
displaying in the inline viewing window at least a portion of the contents of the selected file.

2. The method of claim 1, further comprising setting a size restriction for the inline viewing window, and restricting the display of contents of the selected file within the inline viewing window in dependence upon the set size restriction.

3. The method of claim 2, further comprising setting a maximum expandable size for the inline viewing window.

4. The method of claim 1, further comprising configuring a user actionable control to select a file.

5. The method of claim 1, further comprising configuring automatic selection of the next adjacent file in the list of files.

6. The method of claim 1, further comprising triggering selection of the next adjacent file based on scrolling past the limit of a set size restriction for the inline viewing window for the currently selected file.

7. The method of claim 1, further comprising configuring a user actionable control to unselect a file, such that the inline viewing window for the unselected file is closed.

8. A system for viewing the contents of a file, comprising:
means for receiving a selection of a file in a list of files;
means for opening an inline viewing window adjacent the position of the selected file; and
means for displaying in the inline viewing window at least a portion of the contents of the selected file.

9. The system of claim 8, further comprising means for setting a size restriction for the inline viewing window, and restricting the display of contents of the selected file within the inline viewing window in dependence upon the set size restriction.

10. The system of claim 9, further comprising means for setting a maximum expandable size for the inline viewing window.

11. The system of claim 8, further comprising means for configuring a user actionable control to select a file.

12. The system of claim 8, further comprising means for configuring automatic selection of the next adjacent file in the list of files.

13. The system of claim 12, further comprising means for triggering selection of the next adjacent file based on scrolling past the limit of a set size restriction for the inline viewing window for the currently selected file.

14. The system of claim 8, further comprising means for configuring a user actionable control to unselect a file, such that the inline viewing window for the unselected file is closed.

15. A data processor readable medium containing data processor code that when loaded into a device adapts the device to display the contents of a file, the data processor medium comprising:
code for receiving a selection of a file in a list of files;
code for opening an inline viewing window adjacent the position of the selected file; and
code for displaying in the inline viewing window at least a portion of the contents of the selected file.

16. The data processor medium of claim 15, further comprising code for setting a size restriction for the inline viewing window, and restricting the display of contents of the selected file within the inline viewing window in dependence upon the set size restriction.

17. The data processor readable medium of claim 16, further comprising code for setting a maximum expandable size for the inline viewing window.

18. The data processor readable medium of claim 15, further comprising code for configuring a user actionable control to select a file.

19. The data processor readable medium of claim 15, further comprising code for configuring automatic selection of the next adjacent file in the list of files.

20. The data processor readable medium of claim 19, further comprising code for triggering selection of the next adjacent file based on scrolling past the limit of a set size restriction of the inline viewing window for the currently selected file.

21. The data processor readable medium of claim 15, further comprising code for configuring a user actionable control to unselect a file, such that the inline viewing window for the unselected file is closed.
